(19) United States
(12) Patent Application Publication
(10) Pub. No.: US 2006/0032132 A1
(43) Pub. Date: Feb. 16, 2006

(54) Container with interlocking base

(76) Inventors: Steven W. Liffers, Seaford, DE (US); James A. Kollock, Millsboro, DE (US); Joseph A. Kollock III, Milford, DE (US); Charles J. Eibler JR., Milltown, NJ (US)

Correspondence Address: Adams Evans P.A., 2180 Two Wachovia Center, 301 S. Tryon Street, Charlotte, NC, 28282, US

(21) Appl. No.: 10/896,684

(22) Filed: Jul. 22, 2004

(51) Int. Cl. A01G 9/04

(52) U.S. Cl. 47/71

(57) ABSTRACT

A container having a plant pot and an interlocking base adapted to interlock with the corresponding plant pot. A sidewall, a bottom wall, and an open top define the pot. The bottom wall includes at least one opening defined by the bottom wall of the pot. The base is attached to the bottom wall of the pot. A complementary stud is positioned on the base, and includes at least one locking projection for engaging the opening. The combined horizontal dimension of the stud and projection is greater than a corresponding horizontal dimension of the opening for providing an interference fit, whereby the stud is positioned in the opening and locked in place by forcing the projection past the bottom wall defining the opening.

### TECHNICAL FIELD AND BACKGROUND OF THE INVENTION

This invention relates generally to a container, and more specifically, to a plant pot with an interlocking base adapted to interlock with the corresponding plant pot.

Containers comprising a pot and a base are well known in the art. It is common practice to provide a base or dish under a pot for either watering the plant roots from below or for catching any drainage seeping through drainage holes of the pot. Many prior art containers do not employ a base with a fastener to securely fasten the base to the pot, while other prior art containers use fasteners that either rely on a frictional force to secure the base to the pot, or have hooks that engage the inner surface of a bottom wall of the pot.

For example, U.S. Pat. No. 5,638,638 to Moskowitz discloses a flower pot with an accessible watering base. The watering base includes an array of supports having a linear bar and a peg. The flower pot has a plurality of openings with a center portion through which the peg is received. The openings include a plurality of slits that frictionally engage the peg to secure the watering base to the flower pot.

U.S. Pat. No. 4,092,804 to Morris et al. discloses a flower pot and interlocking saucer. The saucer includes a plurality of locking fasteners which include a tapered arm. The flower pot has a plurality of holes positioned on a bottom wall of the flower pot for receiving the tapered arm of the locking fasteners, securing the base to the flower pot.

While these containers accomplish the purpose of watering plant roots and catching any drainage seeping from the pot, they do not provide a fastener positioned on a base that is capable of securely fastening the base and pot together using a single fastener that interlocks with a opening positioned on the pot via an interference-type fit, and allows the interlocking base to be easily removed without twisting or deforming the base.

Accordingly, there is a need for a container with a pot and interlocking base that can be securely fastened to the container and easily removed with minimal effort.

### SUMMARY OF THE INVENTION

Therefore, it is an object of the invention to provide a container with an interlocking base that is securely fastened to a pot.

It is another object of the invention to provide a container with an interlocking base that is securely fastened to a pot using a single fastener.

It is another object of the invention to provide a container with an interlocking base that has a fastener capable of interlocking with an opening in a pot.

It is another object of the invention to provide a container with an interlocking base that has a opening that forms an expandable receptacle for receiving a complementary fastener.

These and other objects of the present invention are achieved in the preferred embodiments disclosed below by providing a container having a pot defined by a sidewall, a bottom wall, and an open top, the bottom wall having at least one opening defined by the bottom wall of the pot; a base for being attached to the bottom wall of the pot; and a complementary stud being positioned on the base having at least one locking projection for extending through and engaging the opening, the combined horizontal dimension of the stud and projection being greater than a corresponding horizontal dimension of the opening for providing an interference fit, whereby the stud is positioned in the female opening and locked in place by forcing the projection past the bottom wall defining the female opening.

According to another preferred embodiment of the invention, the at least one opening is circular and includes an axially-extending wall segment with a terminal portion of reduced diameter.

According to another preferred embodiment of the invention, the pot further includes at least one drainage hole for permitting excess drainage to escape the pot.

According to another preferred embodiment of the invention, the wall segment has at least one notch formed along a radial axis of the wall segment for permitting the wall segment to deform outwardly when receiving the stud.

According to another preferred embodiment of the invention, the terminal portion includes an inwardly-extending lip positioned on a top edge of the terminal portion for engaging the projection.

According to another preferred embodiment of the invention, the stud is circular in cross-section and includes a tapered sidewall.

According to another preferred embodiment of the invention, the projection comprises a radially-extending ring disposed around a perimeter of the stud for engaging the opening.

According to another preferred embodiment of the invention, the base includes a base wall having a raised support panel for spacing the bottom wall of the pot from the base wall when the base and pot are secured together.

According to another preferred embodiment of the invention, the complementary stud is positioned on the raised support panel to allow the stud to positively engage the opening.

According to another preferred embodiment of the invention, a container including a pot defined by a sidewall, a bottom wall, and an open top, the bottom wall having at least one opening defined by the bottom wall of the pot, the opening including a flexible axially-extending wall segment with a terminal portion having a reduced horizontal dimension; a base for being attached to the bottom wall of the pot; and a complementary stud being positioned on the base having at least one radially-extending ring extending through and engaging the wall segment of the opening, the combined horizontal dimension of the stud and ring being greater than a corresponding horizontal dimension of the terminal portion for providing an interference fit, whereby the stud is positioned in the opening and locked in place by forcing the ring past the terminal portion of the wall segment.

According to another preferred embodiment of the invention, a container includes a pot defined by a sidewall, a bottom wall, and an open top, the bottom wall having a plurality of spaced-apart openings positioned on the bottom wall of the pot, each of the plurality of openings is circular and include a flexible axially-extending wall segment with a terminal portion having a reduced diameter, an inwardly-extending lip is formed on a top edge of the terminal portion; a base defined by a sidewall and a base wall for being attached to the bottom wall of the pot, the base wall having a raised support panel for supporting the pot; and a plurality of complementary studs positioned on the raised support panel having at least one radially-extending ring for engaging the lip of the terminal portion, the combined horizontal dimension of the stud and ring being greater than a corresponding diameter of the terminal portion for providing an interference fit, whereby the stud is positioned in the opening and locked in place by forcing the ring past the lip of the terminal portion.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 shows a perspective view of a plant pot and an interlocking base;

FIG. 2 shows an exploded view of the pot and base;

FIG. 3 shows a side cross-section of the pot;

FIG. 4 shows a top plan view of the pot;

FIG. 5 shows a detail of a locking opening with two notches;

FIG. 6 shows a detail of the locking opening with one notch;

FIG. 7 shows a stud inserted into one of the locking openings;

FIG. 8 shows a detail cross-section of the stud; and

FIG. 9 shows an exploded view of a further embodiment of a pot and interlocking base having a single locking opening and stud.

### DESCRIPTION OF THE PREFERRED EMBODIMENT AND BEST MODE

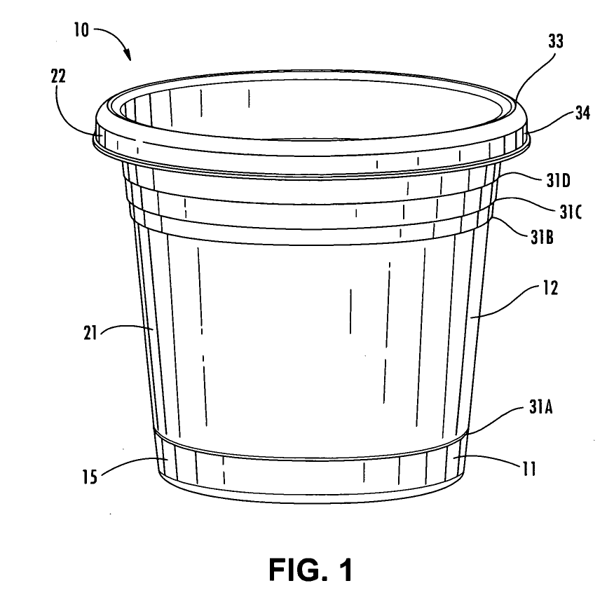

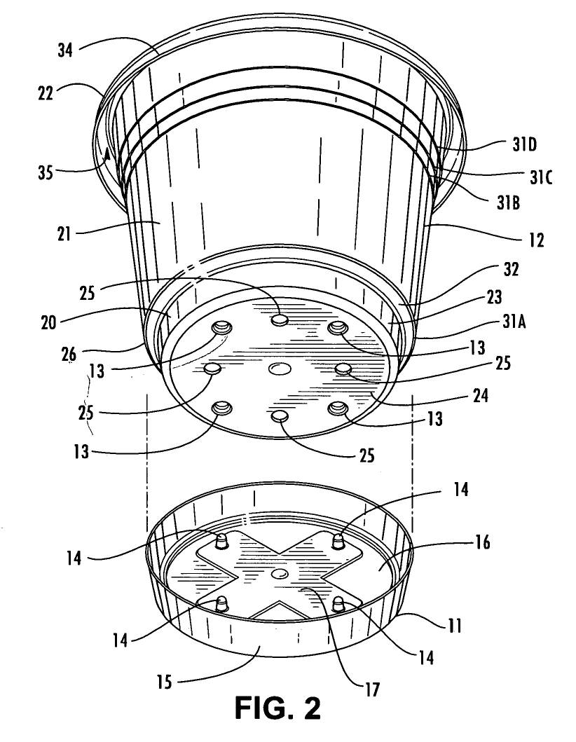

Referring now specifically to the drawings, a container according to an embodiment of the present invention is illustrated in FIGS. 1 and 2 and shown generally at reference numeral 10.

The container 10, as illustrated in FIGS. 1 and 2, has a circular cross-sectional shape. However, it should be noted that the invention is not limited to containers having a circular cross-sectional shape, as other shapes may be used.

The container 10 is formed of an interlocking base 11 and plant pot 12 connected together by locking openings 13 on the pot 12 and complementary studs 14 on the base 11. The vertical cross-sectional dimension of the base 11 and the vertical cross-sectional dimension of an adjacent area of the pot 12 are substantially the same to give the container 10 a generally one-piece appearance.

The pot 12 has a tapered sidewall 21 with a plurality of annular rings 31A, 31B, 31C, and 31 Dof enlarged diameter to provide a larger diameter at the top edge of the pot 12 without the need to increase the length or the angle of taper of the sidewall 30. Additionally, the rings 31A-31D increase the rigidity of the pot 12.

The base 1 1 has a sidewall 15 integrally-formed with a base wall 16. The base wall 16 includes a cross-shaped, substantially flat, raised support panel 17. The support panel 17 acts as a support for the pot 12 when the base 11 and pot 12 are securely attached, creating a reservoir for drainage. The studs 14 are positioned on the support panel 17 in a spaced-apart relation for being received by the openings 13.

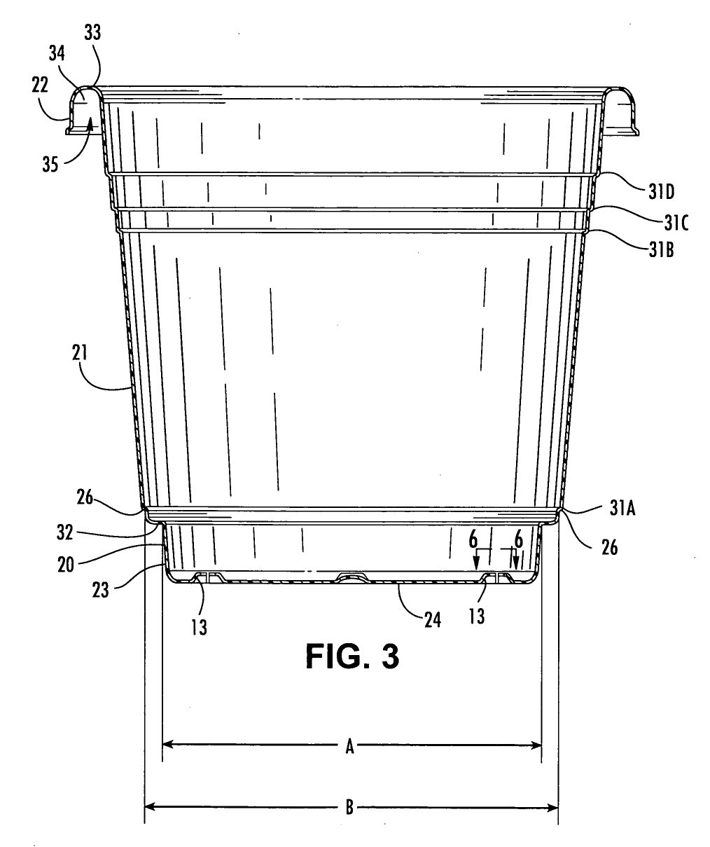

Referring to FIGS. 2-4, the pot 12 has an integrally-formed bottom 20, the sidewall 21, and rim 22.

The bottom 20 has a sidewall 23 and an integrally-formed bottom wall 24. The bottom wall 24 includes a plurality of locking openings 13 for receiving complementary studs 14. The bottom wall 24 also includes a plurality of drainage holes 25 for removing excess water from the pot 12. The dimension “A” of the bottom 20 is less than the dimension “B” at a bottom edge 26 of the sidewall 21 of the pot 12 to allow the base 11 to enclose the bottom 20 and give the appearance of a one-piece container.

The sidewall 21 also includes an inwardly-extending shoulder 32 formed on the bottom edge 26 of the sidewall 21. The shoulder 32 allows the base 11 to fit in a spaced-apart relation over the bottom 20 of the pot 12.

The rim 22 is formed on the top edge of the pot 12 and provides additional rigidity and reinforcement, and permits a user to more easily pick-up the container 10.

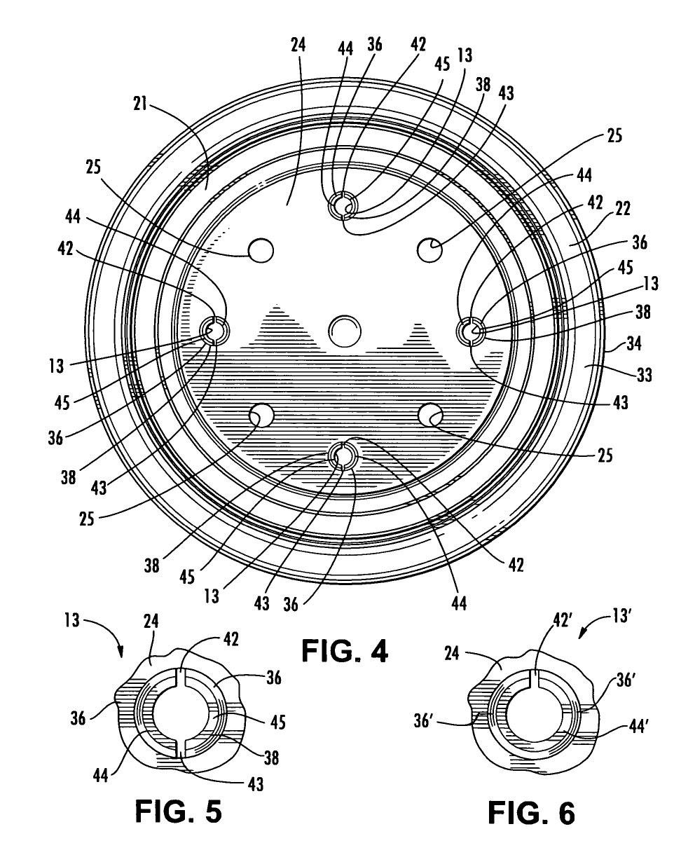

Referring to FIGS. 4-6, each of the openings 13 includes a relatively thin and flexible, axially and radially-extending sidewall 36 projecting from the bottom wall 24 for receiving the stud 14. As illustrated in FIG. 5, the sidewall 36 includes a pair of opposing notches 42 and 43 formed along a radial axis which allow the sidewall 36 to deform outwardly to enlarge the opening 13 when receiving a stud 14. A pair of inwardly-extending lips 44 and 45 are formed on each sidewall 36 to engage the stud 14 and provide an interference fit between the opening 13 and the stud 14.

As shown in FIG. 6, in which prime reference numerals indicate like elements to those in FIG. 5, an opening 13′ may alternatively be formed by the sidewall 36′ having a single notch 42′ formed along a radial axis of the sidewall 36′ to allow the sidewall 36′ to deform outwardly to enlarge the opening 13′ when receiving the stud 14. The inwardly-extending lip 44′ is formed on the sidewall 36′ to engage the stud 14.

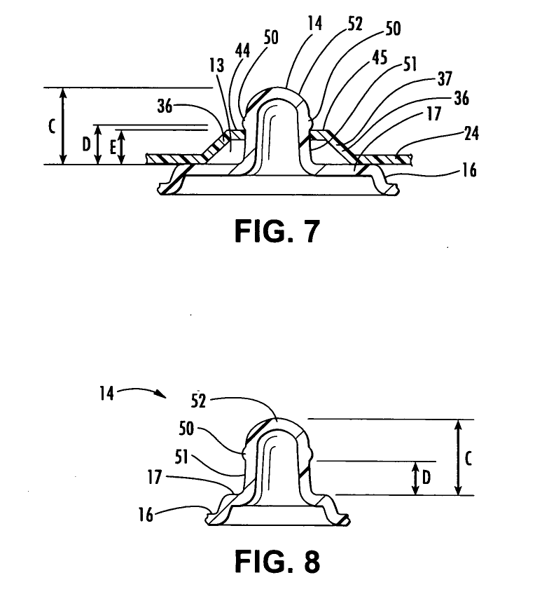

Referring to FIGS. 7 and 8, the stud 14 has a height “C” sufficient to protrude through the opening 13. The stud 14 has a circular cross-section and a continuous sidewall 51 that is slightly tapered to form a stud 14 having a terminal portion 52 of reduced diameter. At least one radially-extending enlarged ring 50 is formed on the stud 14 around the perimeter of the sidewall 51 at a height “D” to engage the lips 44 and 45 with an interference fit and lock the pot 12 to the base 11. The height “D” is slightly larger than a height “E” to allow the bottom wall 24 of the pot 12 to rest on the support panel 17 and the lips 44 and 45 to be positioned just below the ring 50, providing a tight fit between the pot 12 and the base 11.

The base 11 is attached to the pot 12 by aligning the studs 14 with the openings 13 and pressing the pot 12 and base 11 together. When removing the base 11 from the pot 12, the two are pulled apart, causing the studs 14 to release from the openings 13.

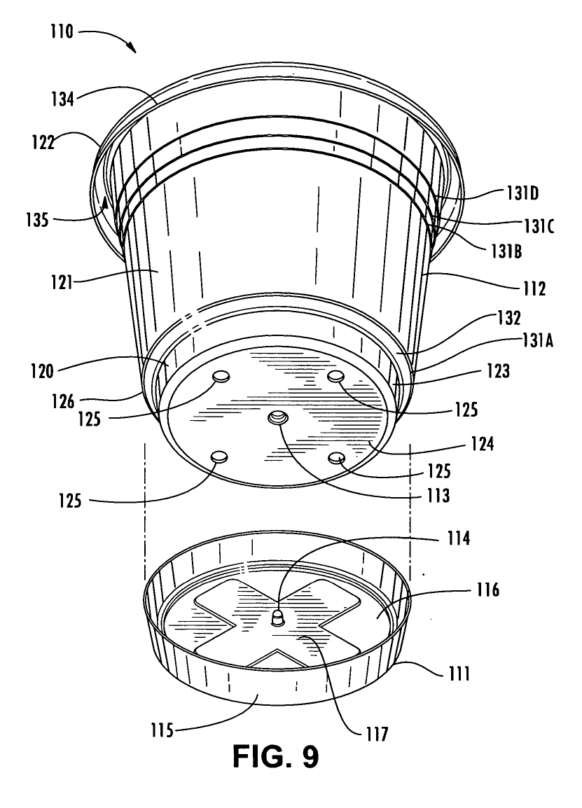

Referring to FIG. 9, a container according to a further embodiment of the present invention is illustrated and shown generally at reference numeral 110. The container 110 is formed of an interlocking base 111 and plant pot 112 connected together by a locking opening 113 and a complementary stud 114.

The pot 112 has a tapered sidewall 121 with a plurality of annular rings 131A, 131B, 131C, and 131D of enlarged diameter to provide a larger diameter at the top edge of the pot 112 without the need to increase the length or the angle of taper of the sidewall 121. Additionally, the rings 131A-131D increase the rigidity of the pot 112.

The base 111 has a sidewall 115 integrally-formed with a base wall 116. The base wall 116 includes a cross-shaped, substantially flat, raised support panel 117 for supporting the pot 112 when the base 111 and pot 112 are securely attached, creating a reservoir for drainage. The stud 114 is positioned on the raised support panel 117 in the center of the base wall 116 for being received by the opening 113.

The pot 112 has an integrally-formed bottom 120, the sidewall 121, and rim 122. The bottom 120 has a sidewall 123 and an integrally-formed bottom wall 124 on which the locking opening 113 is formed. The bottom wall 124 also includes drainage holes 125 for allowing excess water to drain from the pot 112.

The sidewall 121 also includes an inwardly-extending shoulder 32 formed on a bottom edge 126 of the sidewall 121. The shoulder 132 allows the base 111 to fit in a spaced-apart relation over the bottom 120 of the pot 112.

The rim 122 provides additional rigidity and reinforcement, and permits a user to more easily pick-up the container 110.

A container including a plant pot and an interlocking base is described above. Various details of the invention may be changed without departing from its scope. Furthermore, the foregoing description of the preferred embodiments of the invention and the best mode for practicing the invention are provided for the purpose of illustration only and not for the purpose of limitation, the invention being identified in the claims.

1. A container, comprising:
(a) a pot defined by a sidewall, a bottom wall, and an open top, the bottom wall having at least one opening defined by the bottom wall of the pot;
(b) a base for being attached to the bottom wall of the pot; and
(c) a complementary stud positioned on the base, the stud having at least one continuous locking projection disposed around the stud for extending through and engaging the opening, the combined horizontal dimension of the stud and projection being greater than a corresponding horizontal dimension of the opening for providing an interference fit, whereby the stud is positioned in the opening and locked in place by forcing the projection past the bottom wall defining the opening.

2. The container according to claim 1, wherein the pot further includes at least one drainage hole for permitting excess drainage to escape the pot.

3. The container according to claim 1, wherein the at least one opening is circular and includes an axially-extending wall segment with a terminal portion of reduced diameter.

4. The container according to claim 3, wherein the wall segment has at least one notch formed along a radial axis of the wall segment for permitting the wall segment to deform outwardly when receiving the stud.

5. The container according to claim 3, wherein the terminal portion includes an inwardly-extending lip positioned on a top edge of the terminal portion for engaging the projection.

6. The container according to claim 1, wherein the stud is circular in cross-section and includes a tapered sidewall.

7. The container according to claim 1, wherein the projection comprises a radially-extending ring disposed around a perimeter of the stud for engaging the opening.

8. The container according to claim 1, wherein the base includes a base wall having a raised support panel for spacing the bottom wall of the pot from the base wall when the base and pot are secured together.

9. The container according to claim 8, wherein the complementary stud is positioned on the raised support panel to allow the stud to possibly engage the opening.

10. A container, comprising:
(a) a pot defined by a sidewall, a bottom wall, and an open top, the bottom wall having at least one opening defined by the bottom wall of the pot, the opening including a flexible axially-extending wall segment with a terminal portion having a reduced horizontal dimension;
(b) a base for being attached to the bottom wall of the pot, and
(c) a complementary stud being positioned on the base, the stud having at least one continuous radially-extending ring disposed around a perimeter of the stud for extending through and engaging the wall segment of the opening, the combined horizontal dimension of the stud and ring being greater than a corresponding horizontal dimension of the terminal portion for providing an interference fit, whereby the stud is positioned in the opening and locked in place by forcing the ring past the terminal portion of the wall segment.

11. The container according to claim 10, wherein the pot further includes at least one drainage hole for permitting excess drainage to escape the pot

12. The container according to claim 10, wherein the at least one opening is circular.

13. The container according to claim 10, wherein the wall segment has at least one notch formed along a radial axis of the wall segment for permitting the wall segment to deform outwardly when receiving the stud.

14. The container according to claim 10, wherein the terminal portion includes an inwardly-extending lip positioned on a top edge of the terminal portion for engaging the ring.

15. The container according to claim 14, wherein the ring is engages the lip positioned on the top edge of the terminal portion.

16. The container according to claim 10, wherein the stud is circular in cross-section and includes a tapered sidewall.

17. The container according to claim 10, wherein the base includes a base wall having a raised support panel for spacing the bottom wall of the pot from the base wall when the base and pot are secured together.

18. The container according to claim 17, wherein the complementary stud is positioned on the raised support panel to allow the male fastener to positively engage the opening.

19. A container, comprising:
(a) a pot defined by a sidewall, a bottom wall, and an open top, the bottom wall having a plurality of spaced-apart openings positioned on the bottom wall of the pot, each of the plurality of openings is circular and include a flexible axially-extending wall segment with a terminal portion having a reduced diameter, an inwardly-extending lip is formed on a top edge of the terminal portion;
(b) a base defined by a sidewall and a base wall for being attached to the bottom wall of the pot, the base wall having a unitary raised support panel for supporting the pot; and
(c) a plurality of complementary studs positioned in a spaced-apart relation on the unitary raised support panel having at least one radially-extending ring for engaging the lip of the terminal portion, the combined horizontal dimension of the stud and ring being greater than a corresponding diameter of the terminal portion for providing an interference fit, whereby the stud is positioned in the opening and locked in place by forcing the ring past the lip of the terminal portion.

20. The container according to claim 19, wherein the wall segment has at least one notch along a radial axis of the wall segment for permitting the wall segment to deform outwardly when receiving the stud.
